(19) United States
(12) Patent Application Publication
(10) Pub. No.: US 2025/0029613 A1
(43) Pub. Date: Jan. 23, 2025

(54) UTTERANCE SECTION EXTRACTION DEVICE, UTTERANCE SECTION EXTRACTION METHOD AND UTTERANCE SECTION EXTRACTION PROGRAM

(71) Applicant: NIPPON TELEGRAPH AND TELEPHONE CORPORATION, Tokyo (JP)

(72) Inventors: Satoshi MIEDA, Tokyo (JP); Setsuo YAMADA, Tokyo (JP); Takafumi HIKICHI, Tokyo (JP)

(73) Assignee: NIPPON TELEGRAPH AND TELEPHONE CORPORATION, Tokyo (JP)

(21) Appl. No.: 18/715,180

(22) PCT Filed: Dec. 3, 2021
(86) PCT No.: PCT/JP2021/044578

§ 371 Date: May 31, 2024

(51) Int. Cl. G10L 17/02; G10L 17/06

(52) U.S. Cl. CPC G10L 17/02; G10L 17/06

(57) ABSTRACT

A speech section extraction device includes: a speech section identification unit that identifies a speech section including at least one speech from speech text data including speeches of two or more people; a speech section type determination unit that determines a speech section type for each of the speech section that has been identified; a speech type extraction unit that extracts a speech type of each speech included in the speech text data from the speech text data; and a speech section extraction unit that extracts an important speech section among the speech section that has been identified, based on a combination and transition of the speech section type that has been determined, and a combination and transition of the speech type that has been extracted.

### TECHNICAL FIELD

The disclosed technology relates to a speech section extraction device, a speech section extraction method, and a speech section extraction program.

### BACKGROUND ART

In a contact center of a company, an organization, or the like, an operator exchanges a large amount of information such as responding to an inquiry from a client, proposing a product to the client, and selling the product by using a call, a text chat, or the like. Effectively selling products in response to needs and demands of clients while making a large number of calls every day, and accurately answering inquiries leads to improvement in profit and improvement in customer satisfaction.

In order to effectively utilize an opportunity of a call from a client or a call to a client, it is necessary to extract an excellent reception as an example from call data and share or analyze the information within a company or among operators.

The excellent reception made of accumulation of exchanges, and is determined in consideration of a plurality of speeches, transition of speech sections, configurations and questions, frequency of answers, appearance positions, and the like. Such a section is set as an important speech section (hereinafter, referred to as an “important speech section”), and extraction is performed.

For example, it is conceivable to determine the important speech section by a keyword or the like. However, this requires manual confirmation and determination of before and after a speech obtained by a search with a keyword, and it is not possible to narrow down and extract a desired speech section. There is a method in which a speech section is defined, and determination is made on the basis of the degree of similarity of appearance words in the speech unit (see, for example, Patent Literature 1).

### CITATION LIST

### Patent Literature

Patent Literature 1: WO2020/036190

### SUMMARY OF INVENTION

### Technical Problem

According to the technology disclosed in Patent Literature 1, it is possible to determine the importance and the superiority/inferiority in units of sections, but it is not possible to determine the speech section in consideration of the transition of the important speech section.

It is also conceivable to analyze each speech during a call, and to extract a speech including a specific speech progress, development, and the like during the call. However, as illustrated in FIG. 25, although it is possible to grasp a specific speech situation such as “asking about need”, “need does not exist”, “question”, “answer”, or the like as the speech situation, it is not possible to determine and extract a responding pattern in the next speech section in response to an answer or a reaction from the other party.

As illustrated in FIG. 25, a method is also conceivable in which a speech section is defined and a type of the speech section (for example, “open type sales section”, “theme type sales section”, “end type sales section”, and the like) is determined in advance, and the determination is made by a rule on the basis of a combination of the types of the speech sections. However, for the determination of the important speech section, the configuration, frequency, and the like of the speech in the section are important, and the determination cannot be made only with the information of the speech section.

That is, in the conventional technology, section information is determined for each speech section, and an important speech section useful for call analysis such as sales cannot be determined and extracted. When only the analysis information in units of speeches is used, the important speech section cannot be determined in consideration of the transition in units of speech sections.

The disclosed technology has been made in view of the above points, and an object thereof is to provide a speech section extraction device, a speech section extraction method, and a speech section extraction program capable of extracting an important speech section in consideration of each combination and transition of a speech section and a speech.

### Solution to Problem

A first aspect of the present disclosure is a speech section extraction device including: a speech section identification unit that identifies a speech section including at least one speech from speech text data including speeches of two or more people; a speech section type determination unit that determines a speech section type for each of the speech sections identified by the speech section identification unit; a speech type extraction unit that extracts a speech type of each speech included in the speech text data from the speech text data; and a speech section extraction unit that extracts an important speech section among the speech sections identified by the speech section identification unit, on the basis of a combination and transition of the speech section types determined by the speech section type determination unit, and a combination and transition of the speech types extracted by the speech type extraction unit.

A second aspect of the present disclosure is a speech section extraction method including: identifying a speech section including at least one speech from speech text data including speeches of two or more people; determining a speech section type for each of the speech sections that has been identified; extracting a speech type of each speech included in the speech text data from the speech text data; and extracting an important speech section among the speech sections that have been identified, based on a combination and transition of the speech section types that has been determined, and a combination and transition of the speech types that has been extracted.

A third aspect of the present disclosure is a speech section extraction program that causes a computer to execute: identifying a speech section including at least one speech from speech text data including speeches of two or more people; determining a speech section type for each of the speech sections that has been identified; extracting a speech type of each speech included in the speech text data from the speech text data; and extracting an important speech section among the speech sections that have been identified, based on a combination and transition of the speech section types that has been determined, and a combination and transition of the speech types that has been extracted.

### Advantageous Effects of Invention

According to the disclosed technology, there is an effect that an important speech section can be extracted in consideration of a combination and transition of each of a speech section and a speech.

### BRIEF DESCRIPTION OF DRAWINGS

FIG. 1 is a block diagram illustrating an example of a hardware configuration of a speech section extraction device according to an embodiment.

FIG. 2 is a diagram for explaining terms used in the embodiment.

FIG. 3 is a block diagram illustrating an example of a functional configuration of the speech section extraction device according to the embodiment.

FIG. 4 is a diagram illustrating a configuration example of a sentence input unit illustrated in FIG. 3.

FIG. 5 is a diagram illustrating a configuration example of a speech section identification unit illustrated in FIG. 3.

FIG. 6 is a diagram illustrating a configuration example of a speech section type determination unit illustrated in FIG. 3.

FIG. 7 is a diagram illustrating a configuration example of a speech type extraction unit illustrated in FIG. 3.

FIG. 8 is a diagram illustrating a configuration example of a speech section extraction unit illustrated in FIG. 3.

FIG. 9 is a diagram for explaining important speech section extraction processing according to a first embodiment.

FIG. 10 is a flowchart illustrating an example of a flow of processing in a speech section extraction program according to a first embodiment.

FIG. 11 is a flowchart illustrating an example of a flow of important speech section extraction processing according to the first embodiment, and illustrates an example of a rule A of a speech section extraction rule.

FIG. 12 is a flowchart illustrating another example of a flow of important speech section extraction processing according to the first embodiment, and illustrates an example of a rule B of the speech section extraction rule.

FIG. 13 is a diagram illustrating a configuration example of the speech section identification unit according to the second embodiment.

FIG. 14 is a diagram illustrating a configuration example of the speech section type determination unit according to the second embodiment.

FIG. 15 is a diagram illustrating a configuration example of a speech type extraction unit according to the second embodiment.

FIG. 16 is a diagram illustrating a configuration example of a speech section extraction unit according to the second embodiment.

FIG. 17 is a diagram for explaining important speech section extraction processing according to the second embodiment.

FIG. 18 is a diagram for explaining another important speech section extraction processing according to the second embodiment.

FIG. 19 is a flowchart illustrating an example of a flow of speech section extraction processing according to the second embodiment, and illustrates an example of a rule C of a speech section extraction rule.

FIG. 20 is a diagram illustrating a configuration example of the speech section type determination unit according to a third embodiment.

FIG. 21 is a diagram illustrating a configuration example of a speech type extraction unit according to the third embodiment.

FIG. 22 is a diagram illustrating a configuration example of a speech section extraction unit according to the third embodiment.

FIG. 23 is a diagram for explaining important speech section extraction processing according to the third embodiment.

FIG. 24 is a flowchart illustrating an example of a flow of speech section extraction processing according to the third embodiment, and illustrates an example of a rule D of a speech section extraction rule.

FIG. 25 is a diagram for explaining a conventional technology.

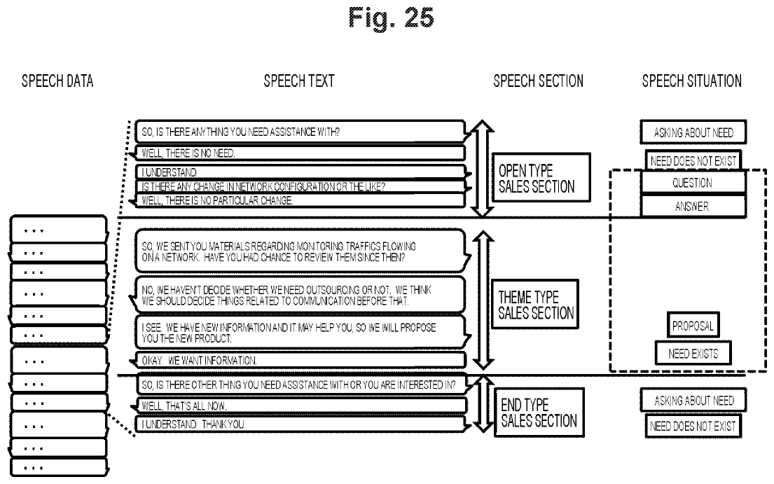

### DESCRIPTION OF EMBODIMENTS

Hereinafter, an example of an embodiment of the disclosed technology will be described with reference to the drawings. In the drawings, the same or equivalent components and portions will be denoted by the same reference signs. Further, dimensional ratios in the drawings are exaggerated for convenience of description and thus may be different from actual ratios.

### [First Embodiment]

A speech section extraction device according to a first embodiment provides a specific improvement over a conventional method of extracting an important speech section without considering combinations and transitions of each of a speech section and a speech, and indicates improvement in a technical field of extracting an important speech section from speech data including speeches of two or more people.

A speech section extraction device according to the present embodiment identifies a speech section to be analyzed, determines a speech section type representing a type of the speech section that has been identified, extracts a speech type of a speech unit, and extracts an important speech section among the identified speech sections on the basis of a combination and transition of each of the speech section type and the speech type.

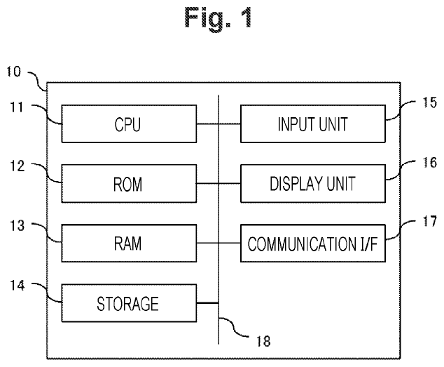

First, a hardware configuration of a speech section extraction device 10 according to the present embodiment will be described with reference to FIG. 1.

FIG. 1 is a block diagram illustrating an example of a hardware configuration of the speech section extraction device 10 according to the present embodiment.

As illustrated in FIG. 1, the speech section extraction device 10 includes a central processing unit (CPU) 11, a read only memory (ROM) 12, a random access memory (RAM) 13, a storage 14, an input unit 15, a display unit 16, and a communication interface (I/F) 17. The components are communicably connected to each other via a bus 18.

The CPU 11 is a central processing unit, which executes various programs and controls each unit. That is, the CPU 11 reads a program from the ROM 12 or the storage 14, and executes the program using the RAM 13 as a working area. The CPU 11 performs control of each of the components described above and various types of calculation processing according to a program stored in the ROM 12 or the storage 14. In the present embodiment, the ROM 12 or the storage 14 stores a speech section extraction program for executing speech section extraction processing to be described later.

The ROM 12 stores various programs and various types of data. The RAM 13, as a work area, temporarily stores programs or data. The storage 14 includes a hard disk drive (HDD) or a solid state drive (SSD) and stores various programs including an operating system and various types of data.

The input unit 15 includes a pointing device such as a mouse and a keyboard and is used to perform various inputs to the allocation search device.

The display unit 16 is, for example, a liquid crystal display and displays various types of information. The display unit 16 may function as the input unit 15 by adopting a touch panel system.

The communication interface 17 is an interface through which the allocation search device communicates with another external device. The communication is performed in conformity to, for example, a wired communication standard such as Ethernet (registered trademark) or fiber distributed data interface (FDDI) or a wireless communication standard such as 4G, 5G, or Wi-Fi (registered trademark).

For example, a general-purpose computer device such as a server computer or personal computer (PC) is applied to the speech section extraction device 10 according to this embodiment.

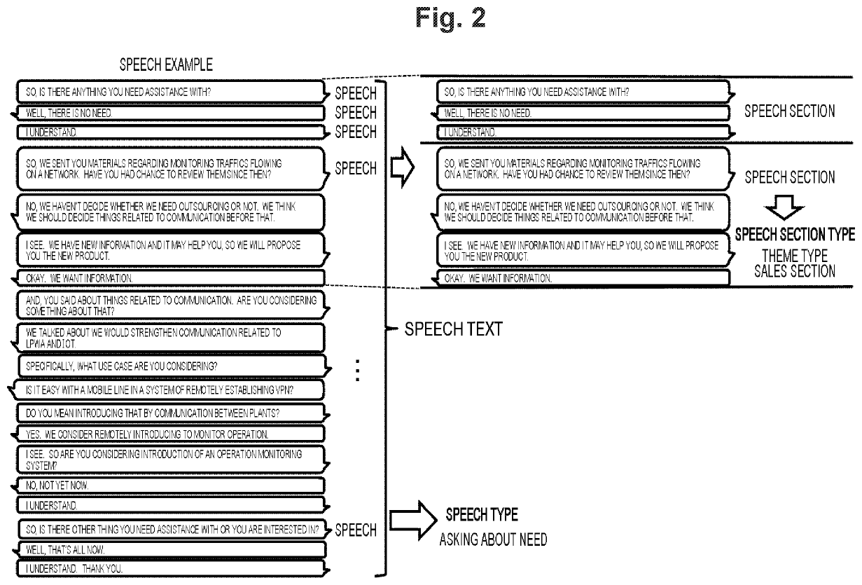

Here, terms used in the present embodiment will be described with reference to FIG. 2.

FIG. 2 is a diagram for explaining terms used in the present embodiment. As illustrated in FIG. 2, the speech is input as one separator from voice recognition, text chat, or the like. The speech text includes all exchanges during one reception and represents a set of all speeches during one call. The speech type represents the type of each speech. The speech type is not affected by preceding and subsequent speeches. The speech type includes, for example, “asking about need” and the like. The speech type ID (Identification) is an ID for identifying a speech type assigned to each speech. The speech section represents a section including at least one speech. The speech section may be a set of a plurality of continuous speeches, and in this case, one speech section includes a plurality of speeches. The speech section is configured as one group from, for example, scenes such as greetings, meanings and contents of speeches, and the like. The speech section may be one speech, and in this case, one speech section includes one speech. The speech section ID is an ID for identifying a speech section assigned to each speech. The speech section type represents the type of each speech section. The speech section type includes, for example, “theme type sales section” and the like. The speech section type ID is an ID for identifying a speech section type for each speech section, the ID being assigned to each speech.

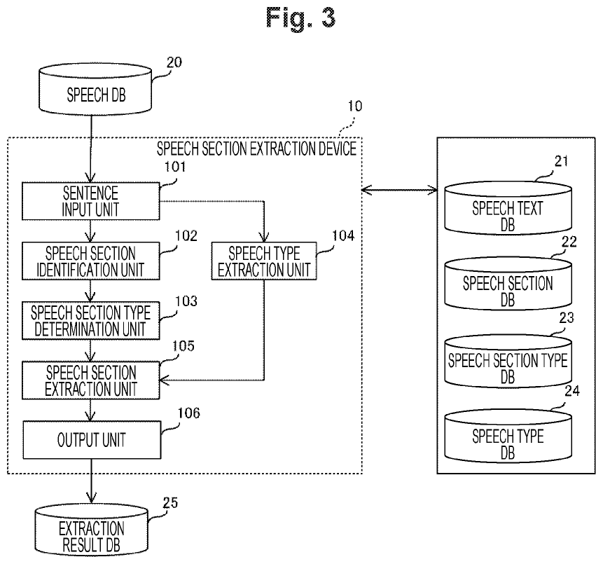

Next, functional configurations of the speech section extraction device 10 will be described with reference to FIG. 3.

FIG. 3 is a block diagram illustrating an example of a functional configuration of the speech section extraction device 10 according to the present embodiment.

As illustrated in FIG. 3, the speech section extraction device 10 includes, as functional configurations, a sentence input unit 101, a speech section identification unit 102, a speech section type determination unit 103, a speech type extraction unit 104, a speech section extraction unit 105, and an output unit 106. Each functional configuration is implemented by the CPU 11 reading a speech section extraction program stored in the ROM 12 or the storage 14, developing the program in the RAM 13, and executing the program.

Each of the speech database (DB) 20 that stores speech data and the extraction result DB 25 that stores extraction result data may be stored in the storage 14 or may be stored in an external accessible storage device. As similar to this, each of the speech text DB 21 that stores speech text data, the speech section DB 22 that stores speech section data, the speech section type DB 23 that stores speech section type data, and the speech type DB 24 that stores speech type data may be stored in the storage 14, or may be stored in an external accessible storage device. In the example of FIG. 3, the speech text data, the speech section data, the speech section type data, and the speech type data are stored in different DBs, but may be stored in one DB.

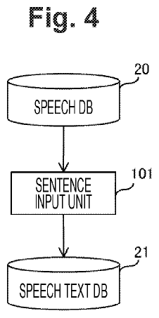

The configuration of each functional unit (sentence input unit 101, speech section identification unit 102, speech section type determination unit 103, speech type extraction unit 104, speech section extraction unit 105, and output unit 106) illustrated in FIG. 3 will be specifically described with reference to FIGS. 4 to 8.

The sentence input unit 101 illustrated in FIG. 4 acquires speech data from the speech DB 20, and stores speech text data obtained by converting the acquired speech data in the speech text DB 21. The speech data is data including speeches of two or more persons, and may be a character string or a voice. When the speech data is a voice, the sentence input unit 101 converts the speech into text by performing voice recognition and stores the text in the speech text DB 21, and when the speech data is a character string, the text has already been converted into text and thus is stored as it is in the speech text DB 21. As the speech data, for example, the speech of the above-described dialogue example illustrated in FIG. 2 is stored in the speech DB 20 as voice, and when the speech data is input as voice, the sentence input unit 101 converts the speech data into text using speech recognition and stores the obtained speech text data in the speech text DB 21.

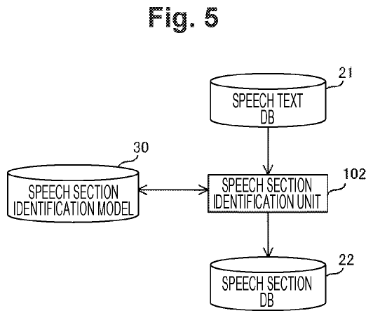

The speech section identification unit 102 illustrated in FIG. 5 acquires speech text data from the speech text DB 21, and stores speech section data obtained by specifying a speech section from the acquired speech text data in the speech section DB 22. Specifically, when speech text data is input, the speech section identification unit 102 identifies a speech section using the speech section identification estimation model 30, and stores the obtained speech section data in the speech section DB 22. The speech section identification model 30 is a learned model that receives speech text data as input and outputs speech section data. As the speech section identification model 30, for example, a deep neural network (DNN), which is a multilayered neural network, is used. The speech section identification model 30 may be stored in the storage 14 or may be stored in an external storage device. As the speech section identification model 30, for example, a model for determining topic switching is generated by assigning a training label to a speech including a clue word indicating topic switching, such as “then” or “by the way”, and performing machine learning using speech text data to which the training label is assigned as learning data. A speech switching is determined using the speech section identification model 30, and a speech from a certain switching to the next switching is identified as a speech section. That is, the speech section identification model 30 determines the switching speech, which is the speech in which the topic in the speech text has changed. A speech section from an opening speech to a speech immediately before a switching speech, a speech from a switching speech to a speech immediately before a next switching speech, and a speech section ID is assigned to each speech.

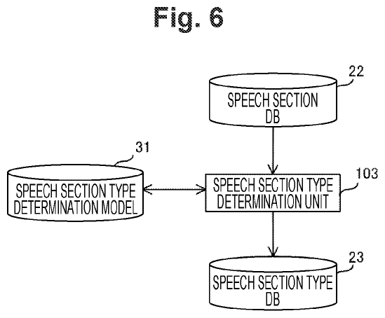

The speech section type determination unit 103 illustrated in FIG. 6 acquires speech section data from the speech section DB 22, and stores the speech section type data obtained by determining the speech section type with respect to the acquired speech section data in the speech section type DB 23. Specifically, when the speech section data is input, the speech section type determination unit 103 determines the speech section type of the speech section using the speech section type determination model 31, and stores the obtained speech section type data in the speech section type DB 23. The speech section type determination model 31 is a learned model that receives speech section data as input and outputs speech section type data. For example, a DNN is used as the speech section type determination model 31. The speech section type determination model 31 may be stored in the storage 14 or may be stored in an external storage device. As the speech section type, for example, the following labels (type 1 to type 4) are defined. A model for determining these speech section types is generated in advance by performing machine learning using learning data attached with these labels. Using the speech section type determination model 31, a speech section type is determined for an input speech section, and a determination result of the speech section type is assigned as a speech section type ID for each speech section.

(Type 1) A section of reception without focusing on a specific topic or theme (hereinafter, referred to as an “open type sales section”.)

(Type 2) A section of confirming the presence or absence of another topic or theme on the client side (hereinafter, referred to as an “end type sales section”.) Specifically, it is a speech section in which a dialogue related to a specific topic or theme is terminated, or a speech section in which the presence or absence of another need is confirmed.

(Type 3) A section of reception to a specific topic or theme, such as a topic prepared in advance (hereinafter, referred to as a “theme type sales section”.)

(Type 4) No type

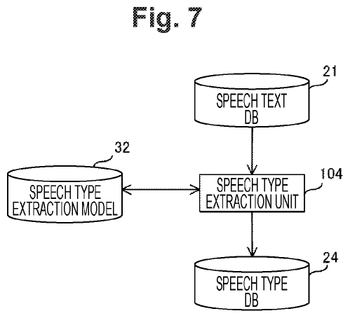

The speech type extraction unit 104 illustrated in FIG. 7 acquires speech text data from the speech text DB 21, and stores the speech type data obtained by extracting the speech type of each speech included in the acquired speech text data in the speech type DB 24. Specifically, when the speech section data is input, the speech type extraction unit 104 estimates the speech type of each speech using the speech type extraction model 32, and stores the obtained speech type data in the speech type DB 24. The speech type extraction model 32 is a learned model that receives speech text data as input and outputs speech type data. For example, a DNN is used as the speech type extraction model 32. The speech type extraction model 32 may be stored in the storage 14 or may be stored in an external storage device. As the speech type, for example, a type is assigned to each of a reception scene of each speech, a speech regarding a dialogue action, and a speech regarding a sales action. In the case of a reception scene, for example, a label such as a speech of a scene for issue grasping, a speech with respect to the issue, and the like is defined. In the case of a speech related to a dialogue action, for example, labels such as “question”, “answer”, and “explanation” are defined. In the case of a speech related to a sales action, for example, labels such as “asking about need”, “need exists”, “need does not exist”, “proposal”, and “question” are defined. A model for extracting these speech types is generated in advance by performing machine learning using speech text data with these labels attached to each speech as learning data. Using the speech type extraction model 32, a speech type of each speech is determined for an input speech text, and a determination result of the speech type for each speech is assigned as a speech type ID for each speech.

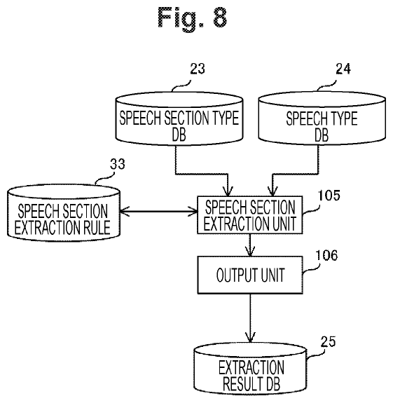

The speech section extraction unit 105 illustrated in FIG. 8 acquires speech section type data from the speech section type DB 23, and acquires speech type data from the speech type DB 24. Then, the speech section extraction unit 105 extracts an important speech section among the speech sections identified by the speech section identification unit 102 on the basis of the combination and transition of the speech section types determined by the speech section type determination unit 103 and the combination and transition of the speech types extracted by the speech type extraction unit 104. Specifically, the speech section extraction unit 105 performs extraction using the speech section extraction rule 33. In the speech section extraction rule 33, combinations and transitions of speech section types and combinations and transitions of speech types are determined in advance in association with important speech sections. For example, when a speech type indicating a speech regarding sales performed by an operator to a client is included and a combination of speech section types indicating a plurality of continuous speech sections designated in advance as unimportant sections is not included, the speech section extraction rule 33 extracts a plurality of speech sections as important speech sections. This makes it possible to accurately extract an important speech section in a case where one speech section includes a plurality of speeches.

The speech section extraction rule 33 includes, for example, a rule A described below. When the rule A is satisfied, it is determined as an important section.

### (Rule A)

a1. The continuous speech sections are three or more sections.

a2. A speech section type combination (C1 to C4) designated as the following unimportant section is not included.

(C1) “Open type sales section”→“Open type sales section”→“Others”

(C2) “Open type sales section”→“Open type sales section”→“Open type sales section”

(C3) “Open type sales section”→“Open type sales section”→“End type sales section”

(C4) “End type sales section”→“End type sales section”→“Others”

The speech section extraction rule 33 includes, for example, a rule B described below. When the rule B is satisfied, it is determined as an important section.

### (Rule B)

b1. The speech type includes “responding” in the reception scene of the speech included in the speech section.

b2. Regarding the speech included in the speech section, the speech type includes n speech related to sales, such as “asking about need”.

b3. When there is a speech of a reply from the customer to the “asking about need” speech of the operator and the reaction is negative (“Need does not exist”), then the operator performs “suggestion” or “question”.

b4. There is a certain number or more of speeches of “question”.

b5. The number of “questions” is large in the first half of the speech section.

b6. The proposal is made after a plurality of “questions” are repeated.

The output unit 106 illustrated in FIG. 8 acquires the extraction result data extracted by the speech section extraction unit 105, and stores the acquired extraction result data in the extraction result DB 25.

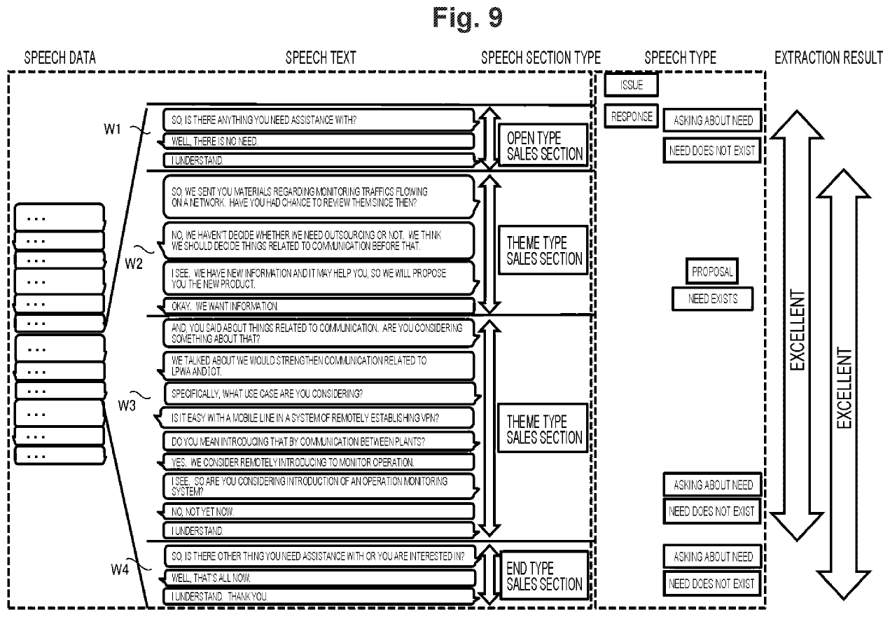

Next, the important speech section extraction processing according to the first embodiment will be specifically described with reference to FIG. 9.

FIG. 9 is a diagram for explaining the important speech section extraction processing according to the first embodiment. The speech text illustrated in FIG. 9 includes a speech of an operator and a speech of a client (customer). The speech text includes a plurality of speech sections W1 to W4, and each of the speech sections W1 to W4 includes a plurality of speeches.

As illustrated in FIG. 9, the speech section type of the speech section W1 is “open type sales section”, the speech section type of the speech section W2 is “theme type sales section”, the speech section type of the speech section W3 is “theme type sales section”, and the speech section type of the speech section W4 is “end type sales section”. The speech section W1 includes speeches of “responding”, “asking about need”, and “need does not exist”, and the speech section W2 includes speeches of “proposal” and “need exists”. The speech section W3 includes speeches of “asking about need” and “need does not exist”, and the speech section W4 includes speeches of “asking about need” and “need does not exist”.

In the example of FIG. 9, as described above, a speech type indicating a speech regarding sales performed by an operator to a client is included and a combination (the above-mentioned combinations C1 to C4) of speech section types indicating a plurality of continuous speech sections designated in advance as unimportant sections is not included. The combination of the plurality of continuous speech sections regarded as the unimportant section is a combination that includes at least one of the “open type sales section” and the “end type sales section” among the “open type sales section”, the “theme type sales section”, and the “end type sales section”, and does not include the “theme type sales section”. That is, the speech sections W1 to W3 are extracted as important (excellent) speech sections since the speech type is “responding” and includes speeches related to sales such as “asking about need”, and the combination of the speech section types is a transition of “open type sales section”→“theme type sales section”→“theme type sales section”. In addition, the speech sections W2 to W4 are extracted as important (excellent) speech sections since the speech type is “responding” and includes speeches related to sales such as “asking about need”, and the combination of the speech section types is a transition of “theme type sales section”→“theme type sales section” →“end type sales section”.

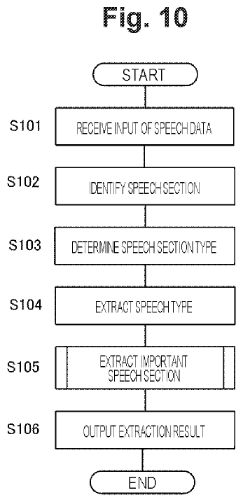

Next, the operation of the speech section extraction device 10 according to the first embodiment will be described with reference to FIG. 10.

FIG. 10 is a flowchart illustrating an example of a flow of processing in the speech section extraction program according to the first embodiment. The processing by the speech section extraction program is implemented by the CPU 11 of the speech section extraction device 10 writing the speech section extraction program stored in the ROM 12 or the storage 14 into the RAM 13 and executing the program. In step S101 of FIG. 10, the CPU 11 receives an input of speech data from the speech DB 20, and stores speech text data obtained by converting the received speech data in the speech text DB 21.

In step S102, the CPU 11 acquires speech text data from the speech text DB 21, identifies a speech section corresponding to the acquired speech text data using the speech section identification model 30, and stores the acquired speech section data in the speech section DB 22.

In step S103, the CPU 11 acquires speech section data from the speech section DB 22, determines the speech section type with respect to the acquired speech section data by using the speech section type determination model 31, and stores the obtained speech section type data in the speech section type DB 23.

In step S104, the CPU 11 acquires speech text data from the speech text DB 21, extracts the speech type of each speech included in the acquired speech text data by using the speech type extraction model 32, and stores the obtained speech type data in the speech type DB 24.

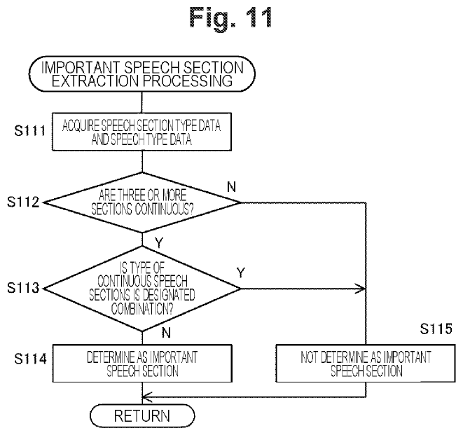

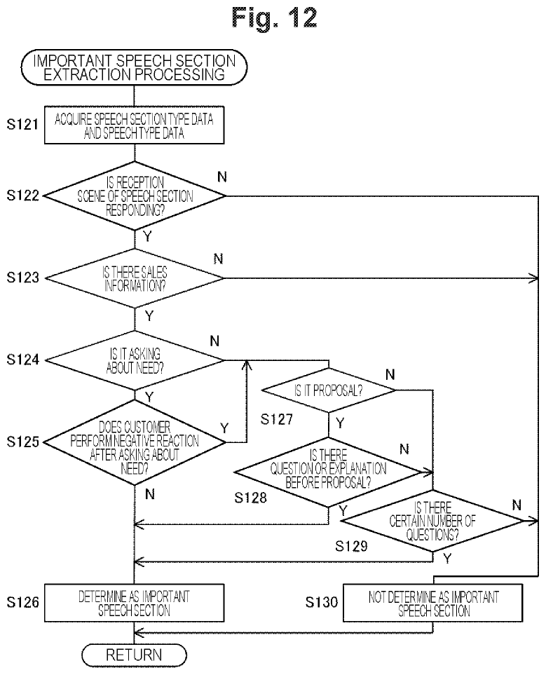

In step S105, the CPU 11 acquires the speech section type data from the speech section type DB 23 and acquires the speech type data from the speech type DB 24, and extracts an important speech section among the speech sections identified in step S102 on the basis of the combination and transition of the speech section types determined in step S103 and the combination and transition of the speech types extracted in step S104. Specifically, the extraction is performed by using the speech section extraction rule 33. A specific example of this important speech section extraction processing will be described with reference to FIGS. 11 and 12.

FIG. 11 is a flowchart illustrating an example of a flow of the important speech section extraction processing according to the first embodiment, and illustrates an example of a rule A of the speech section extraction rule 33.

In step S111, the CPU 11 acquires speech section type data from the speech section type DB 23, and acquires speech type data from the speech type DB 24.

In step S112, the CPU 11 determines whether three or more speech sections are continuous from the speech section type data and the speech type data acquired in step S111. When it is determined that three or more speech sections are continuous (in the case of positive determination), the process proceeds to step S113, and when it is determined that three or more speech sections are not continuous (in the case of negative determination), the process proceeds to step S115.

In step S113, the CPU 11 determines whether a combination of continuous speech section types is a combination (for example, the above-mentioned combinations C1 to C4 of the unimportant sections) of unimportant sections designated in advance. When it is determined that the combination is not a combination of unimportant sections designated in advance (in the case of negative determination), the process proceeds to step S114, and when it is determined that the combination is a combination of unimportant sections designated in advance (in the case of positive determination), the process proceeds to step S115.

In step S114, the CPU 11 determines that continuous speech sections are important speech sections, and the process returns to step S106 in FIG. 10.

In step S115, the CPU 11 determines that the speech sections are not important speech sections, and the process returns to step S106 in FIG. 10.

FIG. 12 is a flowchart illustrating another example of a flow of the important speech section extraction processing according to the first embodiment, and illustrates an example of a rule B of the speech section extraction rule 33. The processing of FIG. 12 may be performed as processing independent of the processing of FIG. 11, or may be performed following the processing of FIG. 11 for the speech section determined to be the important speech section in the processing of FIG. 11.

In step S121, the CPU 11 acquires speech section type data from the speech section type DB 23, and acquires speech type data from the speech type DB 24.

In step S122, the CPU 11 determines whether the reception scene of the speech section is “responding” from the speech section type data and the speech type data acquired in step S121. When it is determined that it is “responding” (in the case of positive determination), the process proceeds to step S123, and when it is determined that it is not “responding” (in the case of negative determination), the process proceeds to step S130.

In step S123, the CPU 11 determines whether there is a speech related to sales (that is, the sales information) in the speech type. The speech related to sales is, for example, a speech to which a type such as “asking about need”, “need exists”, “need does not exist”, or “proposal” is added. When it is determined that the there is a speech related to sales (sales information) (in the case of positive determination), the process proceeds to step S124, and when it is determined that there is no speech related to sales (sales information) (in the case of negative determination), the process proceeds to step S130.

In step S124, the CPU 11 determines whether the speech related to sales (the sales information) is “asking about need”. When it is determined that the it is “asking about need” (in the case of positive determination), the process proceeds to step S125, and when it is determined that it is not “asking about need” (in the case of negative determination), the process proceeds to step S127.

In step S125, the CPU 11 determines whether the customer shows a negative reaction (“need does not exist”) after the “asking about need”. When it is determined that the customer does not show a negative reaction (“need does not exist”) (in the case of negative determination), the process proceeds to step S126, and when it is determined that the customer shows a negative reaction (“need does not exist”) (in the case of positive determination), the process proceeds to step S127.

In step S126, the CPU 11 determines that the speech section is an important speech section, and the process returns to step S106 in FIG. 10.

On the other hand, in step S127, the CPU 11 determines whether the speech related to sales (the sales information) is “proposal”. When it is determined that it is “proposal” (in the case of positive determination), the process proceeds to step S128, and when it is determined that it is not “proposal” (in the case of negative determination), the process proceeds to step S129.

In step S128, the CPU 11 determines whether there is a “question” or an “explanation” before the “proposal”. When it is determined that there is “question” or “explanation” (in the case of positive determination), the process proceeds to step S126, and when it is determined that there is no “question” or “explanation” (in the case of negative determination), the process proceeds to step S129.

In step S129, the CPU 11 determines whether there is a certain number of “questions” in the speech section. When it is determined that there is a certain number of “questions” (in the case of positive determination), the process proceeds to step S126, and when it is determined that there is not a certain number of “questions” (in the case of negative determination), the process proceeds to step S130.

In step S130, the CPU 11 determines that the speech sections are not important speech sections, and the process returns to step S106 in FIG. 10.

Returning to step S106 in FIG. 10, the CPU 11 outputs the extraction result data obtained by extracting as the important speech section in step S105 to the extraction result DB 25, and terminates the series of processing by the speech section extraction program.

As described above, according to the present embodiment, when one speech section includes a plurality of speeches, it is possible to accurately extract an important speech section by considering each combination and transition of the speech section type and the speech type.

Furthermore, by determining the combination and transition of the speech sections by using the extraction and determination of the speech sections and the analysis information of the speech unit, it is possible to determine and extract an important section including a plurality of speech sections based on the combination and transition of the speech sections and the combination and transition of the speech.

Furthermore, for determination of an important or excellent speech section, an important speech section can be determined in consideration of information obtained from individual speeches.

Furthermore, by configuring the speech section type of the speech section not to depend on the object to be analyzed and the object to be used, and configuring the speech type of each speech to depend on the object to be analyzed and the object to be used, or vice versa, the model can be replaced according to the object to be applied.

Furthermore, it is possible to determine an excellent method of developing sales in a sales call.

### [Second Embodiment]

As similar to the first embodiment described above, a speech section extraction device according to a second embodiment provides a specific improvement over a conventional method of extracting an important speech section without considering combinations and transitions of each of a speech section and a speech, and indicates improvement in a technical field of extracting an important speech section from speech data including speeches of two or more people.

In the first embodiment described above, a form in which a plurality of speeches are included in one speech section has been described, but in the second embodiment, a form in which one speech is included in one speech section will be described.

The speech section extraction device (hereinafter, referred to as the speech section extraction device 10A) according to the second embodiment includes, as functional configurations, a sentence input unit 101, a speech section identification unit 102A, a speech section type determination unit 103A, a speech type extraction unit 104A, a speech section extraction unit 105A, and an output unit 106. Repeated description of the sentence input unit 101 and the output unit 106 will be omitted.

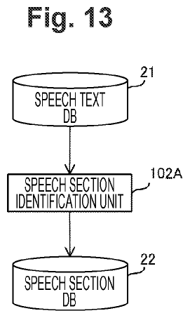

The configuration of each functional unit (speech section identification unit 102A, speech section type determination unit 103A, speech type extraction unit 104A, and speech section extraction unit 105A) according to the second embodiment will be specifically described with reference to FIGS. 13 to 16.

The speech section identification unit 102A illustrated in FIG. 13 acquires speech text data from the speech text DB 21, and stores speech section data obtained by identifying a speech section from the acquired speech text data in the speech section DB 22. Specifically, when speech text data is input, the speech section identification unit 102A specifies a single speech as a speech section, and stores the obtained speech section data in the speech section DB 22.

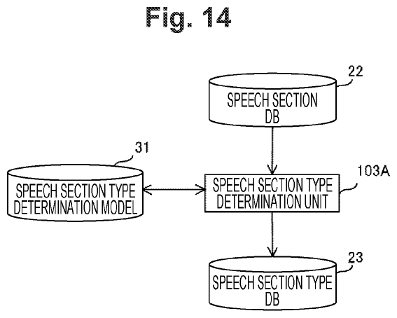

The speech section type determination unit 103A illustrated in FIG. 14 acquires speech section data from the speech section DB 22, and stores the speech section type data obtained by determining the speech section type with respect to the acquired speech section data in the speech section type DB 23. Specifically, when the speech section data is input, the speech section type determination unit 103A determines the speech section type of the speech section using the speech section type determination model 31, and stores the obtained speech section type data in the speech section type DB 23. As the speech section type, for example, a label (for example, “question”, “explanation”, “answer”, “other”, and the like) representing a basic dialogue action in reception is defined. A model for determining these speech section types is generated in advance by performing machine learning using learning data attached with these labels. Using the speech section type determination model 31, a speech section type is determined for an input speech section, and a determination result of the speech section type is assigned as a speech section type ID for each speech section.

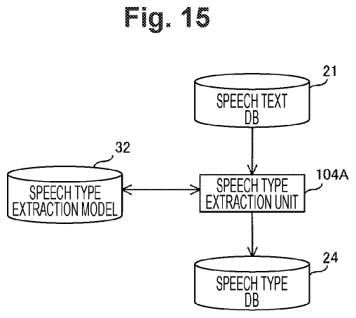

The speech type extraction unit 104A illustrated in FIG. 15 acquires speech text data from the speech text DB 21, and stores the speech type data obtained by extracting the speech type of each speech included in the acquired speech text data in the speech type DB 24. Specifically, when the speech section data is input, the speech type extraction unit 104A estimates the speech type of each speech using the speech type extraction model 32, and stores the obtained speech type data in the speech type DB 24. As the speech type, for example, a type is assigned to each of a reception scene of each speech, a speech regarding a dialogue action, and a speech regarding a sales action. In the case of a reception scene, for example, a label such as a speech of a scene for issue grasping, a speech with respect to the issue, and the like is defined. In the case of a speech related to a dialogue action, for example, labels such as “question”, “answer”, and “explanation” are defined. In the case of a speech related to a sales action, for example, labels such as “asking about need”, “need exists”, “need does not exist”, and “proposal” are defined. A model for extracting these speech types is generated in advance by performing machine learning using speech text data with these labels attached to each speech as learning data. Using the speech type extraction model 32, a speech type of each speech is determined for an input speech text, and a determination result of the speech type for each speech is assigned as a speech type ID for each speech.

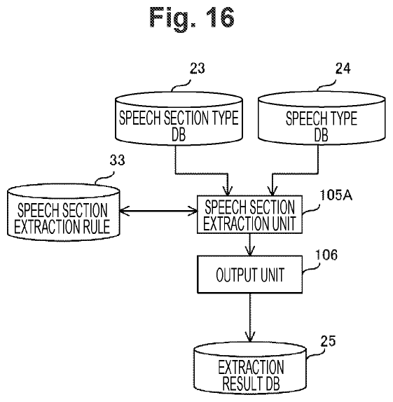

The speech section extraction unit 105A illustrated in FIG. 16 acquires speech section type data from the speech section type DB 23, and acquires speech type data from the speech type DB 24. Then, the speech section extraction unit 105A extracts an important speech section among the speech sections identified by the speech section identification unit 102A on the basis of the combination and transition of the speech section types determined by the speech section type determination unit 103A and the combination and transition of the speech types extracted by the speech type extraction unit 104A. Specifically, the speech section extraction unit 105A performs extraction using the speech section extraction rule 33. In the speech section extraction rule 33, combinations and transitions of speech section types and combinations and transitions of speech types are determined in advance in association with important speech sections. For example, in the case of not including the speech type (“need does not exist”) indicating a speech representing that there is no client's need in sales conducted by an operator to the client, and including the speech section type (“question”) indicating a speech section to be questioned by the operator to the client before the speech type (“proposal”) indicating a speech proposed by the operator to the client, the speech section extraction rule 33 extracts one group including a plurality of speech sections as an important speech section. This makes it possible to accurately extract an important speech section even in a case where one speech section includes a single speech.

The speech section extraction rule 33 includes, for example, a rule C described below. When the rule C is satisfied, it is determined as an important section.

### (Rule C)

Including one or more “questions” and not including “need does not exist” before “proposal” after switching.

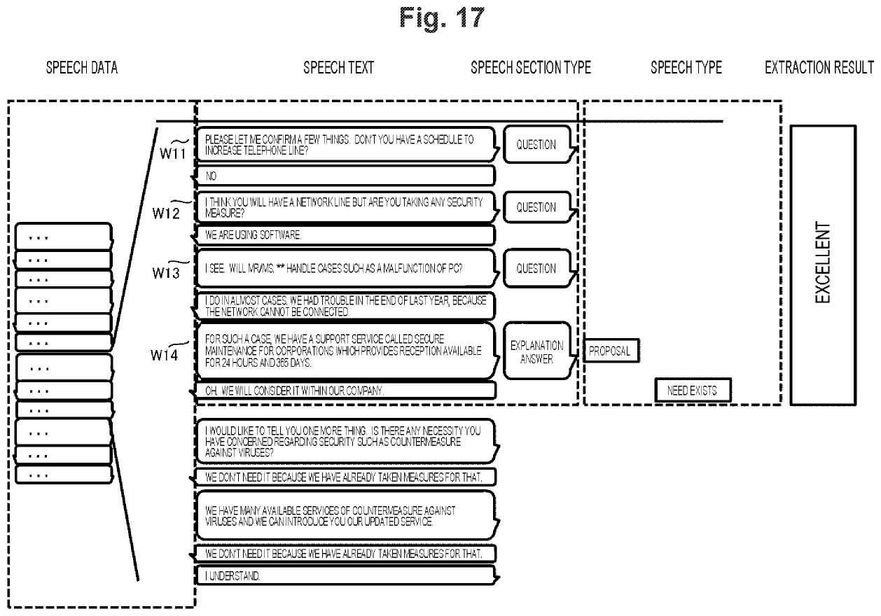

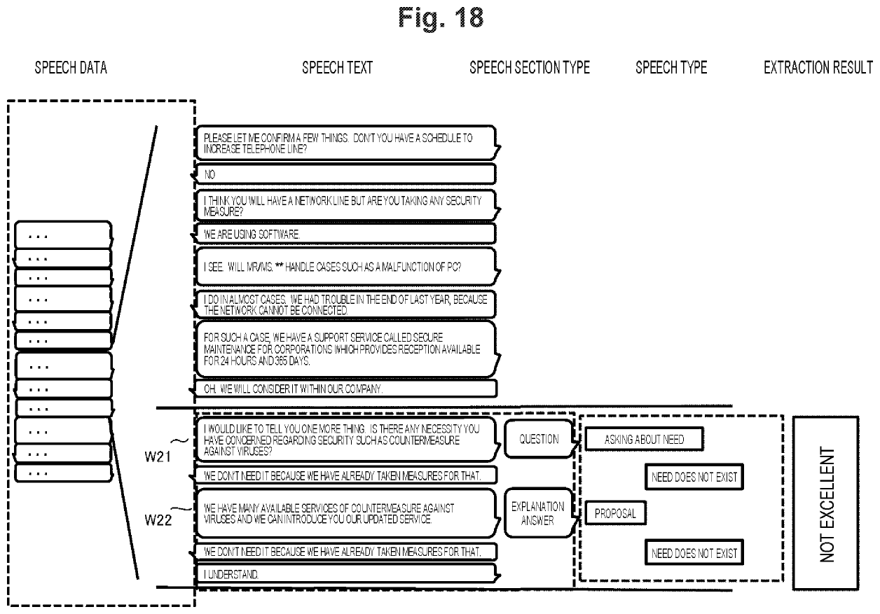

Next, the important speech section extraction processing according to the second embodiment will be specifically described with reference to FIGS. 17 and 18.

FIG. 17 is a diagram for explaining the important speech section extraction processing according to the second embodiment. The speech text illustrated in FIG. 17 includes a speech of an operator and a speech of a client (customer). The speech text includes a plurality of speech sections W11 to W14, and each of the speech sections W11 to W14 includes a single speech.

As illustrated in FIG. 17, the speech section type of each of the speech sections W11, W12, and W13 is “question”, and the speech section type of the speech section W14 is “explanation and answer”. The plurality of speech sections W11 to W14 include speeches of “proposal” and “need exists” as one group from the switching speech, the scene information, and the like.

In the example of FIG. 17, as described above, the speech type (“need does not exist”) indicating a speech representing that there is no client's need in sales conducted by an operator to the client is not included, and the speech section type (“question”) indicating a speech section to be questioned by the operator to the client before the speech type (“proposal”) indicating a speech proposed by the operator to the client is included. That is, since there is at least one “question” and there is no “need does not exist” before the “proposal” after the switching of the speech, the sections are extracted as a group of important (excellent) speech sections.

FIG. 18 is a diagram for explaining another important speech section extraction processing according to the second embodiment. As similar to the example of FIG. 17, the speech text illustrated in FIG. 18 includes a speech of an operator and a speech of a client (customer). The speech text includes a plurality of speech sections W21 and W22, and each of the speech sections W21 and W22 includes a single speech.

As illustrated in FIG. 18, the speech section type of the speech section W21 is “question”, and the speech section type of the speech section W22 is “explanation and answer”. The plurality of speech sections W21 and W22 include speeches of “asking about need”, “need does not exist”, “proposal” and “need exists” as one group from the switching speech, the scene information, and the like.

In the example of FIG. 18, since there is at least one “question” and there is “proposal” after the “need does not exist” before the “proposal” after the switching of the speech, the sections are extracted as a group of not important (excellent) speech sections.

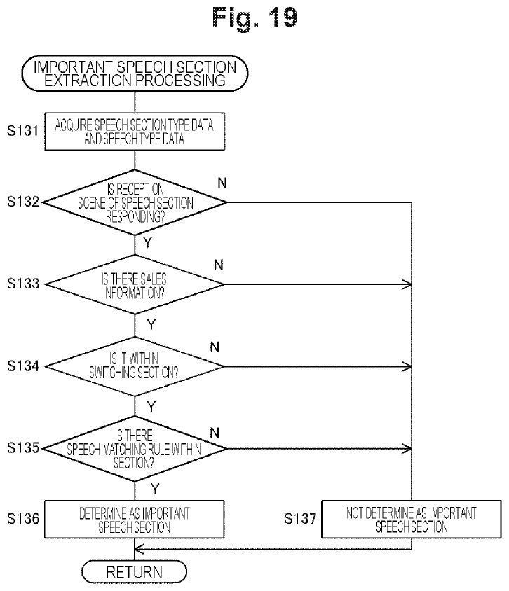

Next, the speech section extraction processing according to the second embodiment will be described with reference to FIG. 19.

FIG. 19 is a flowchart illustrating an example of a flow of speech section extraction processing according to the second embodiment, and illustrates an example of a rule C of the speech section extraction rule 33.

In step S131, the CPU 11 acquires speech section type data from the speech section type DB 23, and acquires speech type data from the speech type DB 24.

In step S132, the CPU 11 determines whether the reception scene of the speech section is “responding” from the speech section type data and the speech type data acquired in step S131. When it is determined that it is “responding” (in the case of positive determination), the process proceeds to step S133, and when it is determined that it is not “responding” (in the case of negative determination), the process proceeds to step S137.

In step S133, the CPU 11 determines whether there is a speech related to sales (that is, the sales information) in the speech type. The speech related to sales is, for example, a speech to which a type such as “asking about need”, “need exists”, “need does not exist”, or “proposal” is added. When it is determined that the there is a speech related to sales (sales information) (in the case of positive determination), the process proceeds to step S134, and when it is determined that there is no speech related to sales (sales information) (in the case of negative determination), the process proceeds to step S137.

In step S134, the CPU 11 determines whether it is within the switching section. When it is determined that it is within the switching section (in the case of positive determination), the process proceeds to step S135, and when it is determined that it is not within the switching section (in the case of negative determination), the process proceeds to step S137.

In step S135, the CPU 11 determines whether there is a speech that matches a rule (for example, “need exists” after “proposal”, or the like.) in the switching section. When it is determined that there is a speech that matches a rule in the switching section (in the case of positive determination), the process proceeds to step S136, and when it is determined that there is no speech that matches a rule (in the case of negative determination), the process proceeds to step S137.

In step S136, the CPU 11 determines that the switching section is an important speech section, and the process returns to the above-mentioned step S106 in FIG. 10.

In step S137, the CPU 11 determines that the switching section is not an important speech section, and the process returns to the above-mentioned step S106 in FIG. 10.

As described above, according to the present embodiment, when one speech section includes a single speech, it is possible to accurately extract an important speech section by considering each combination and transition of the speech section type and the speech type.

### [Third Embodiment]

As similar to the first embodiment described above, a speech section extraction device according to a third embodiment provides a specific improvement over a conventional method of extracting an important speech section without considering combinations and transitions of each of a speech section and a speech, and indicates improvement in a technical field of extracting an important speech section from speech data including speeches of two or more people.

In the third embodiment, a form applied to the check of the compliance of the talk script will be described. The talk script is a script for a dialogue used when an operator responds to a client in telephone sales, a contact center, or the like.

The speech section extraction device (hereinafter, referred to as the speech section extraction device 10B) according to the third embodiment includes, as functional configurations, a sentence input unit 101, a speech section identification unit 102, a speech section type determination unit 103B, a speech type extraction unit 104B, a speech section extraction unit 105B, and an output unit 106. Repeated description of the sentence input unit 101, the speech section identification unit 102, and the output unit 106 will be omitted.

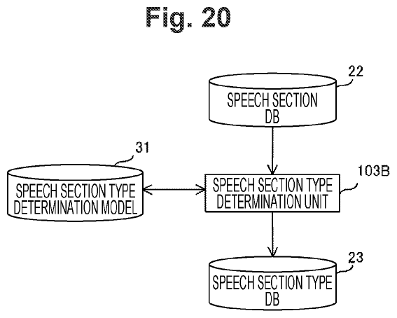

The configuration of each functional unit (speech section type determination unit 103B, speech type extraction unit 104B, and speech section extraction unit 105B) according to the third embodiment will be specifically described with reference to FIGS. 20 to 22.

The speech section type determination unit 103B illustrated in FIG. 20 acquires speech section data from the speech section DB 22, and stores the speech section type data obtained by determining the speech section type with respect to the acquired speech section data in the speech section type DB 23. Specifically, when the speech section data is input, the speech section type determination unit 103B determines the speech section type of the speech section using the speech section type determination model 31, and stores the obtained speech section type data in the speech section type DB 23. As the speech section type, for example, the following labels (type 11 to type 13) are defined. A model for determining these speech section types is generated in advance by performing machine learning using learning data attached with these labels. Using the speech section type determination model 31, a speech section type is determined for an input speech section, and a determination result of the speech section type is assigned as a speech section type ID for each speech section.

(Type 11) Section of confirming client's request content (hereinafter, referred to as a “request content confirmation section”.)

(Type 12) Section of confirming a client's environment situation (hereinafter, referred to as a “client environment confirmation section”.)

(Type 13) Section of responding client's request content (hereinafter, referred to as a “request content responding section”.)

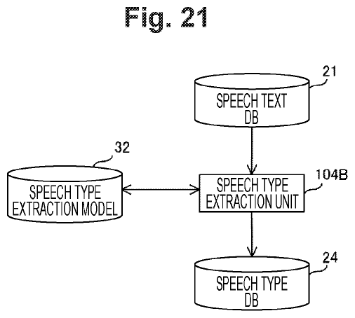

The speech type extraction unit 104B illustrated in FIG. 21 acquires speech text data from the speech text DB 21, and stores the speech type data obtained by extracting the speech type of each speech included in the acquired speech text data in the speech type DB 24. Specifically, when the speech section data is input, the speech type extraction unit 104B estimates the speech type of each speech using the speech type extraction model 32, and stores the obtained speech type data in the speech type DB 24. As the speech type, for example, a type is assigned to each of a reception scene of each speech, a speech regarding a dialogue action, and a speech regarding a sales action. In the case of a reception scene, for example, a label such as a speech of a scene for issue grasping, a speech with respect to the issue, and the like is defined.

In the case of a speech related to a dialogue action, for example, labels such as “question”, “answer”, and “explanation” are defined. In the case of a speech related to a sales action, for example, labels such as “asking about need”, “need exists”, “need does not exist”, and “proposal” are defined. A model for extracting these speech types is generated in advance by performing machine learning using speech text data with these labels attached to each speech as learning data. Using the speech type extraction model 32, a speech type of each speech is determined for an input speech text, and a determination result of the speech type for each speech is assigned as a speech type ID for each speech.

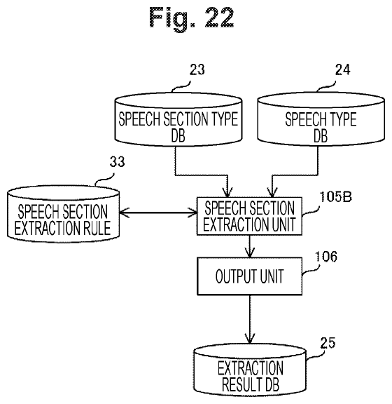

The speech section extraction unit 105B illustrated in FIG. 22 acquires speech section type data from the speech section type DB 23, and acquires speech type data from the speech type DB 24. Then, the speech section extraction unit 105B extracts an important speech section among the speech sections identified by the speech section identification unit 102 on the basis of the combination and transition of the speech section types determined by the speech section type determination unit 103B and the combination and transition of the speech types extracted by the speech type extraction unit 104B. Specifically, the speech section extraction unit 105B performs extraction using the speech section extraction rule 33. In the speech section extraction rule 33, combinations and transitions of speech section types and combinations and transitions of speech types are determined in advance in association with important speech sections. For example, in the case of including a combination of speech section types indicating a plurality of continuous speech sections designated in advance as the important section, and including a combination of speech types indicating speeches designated in advance in each of the plurality of continuous speech sections, the speech section extraction rule 33 extracts the plurality of speech sections as the important speech sections. As a result, even when one speech section includes a plurality of speeches and the speech section is applied to check compliance of a talk script, it is possible to accurately extract an important speech section.

The speech section extraction rule 33 includes, for example, a rule D described below. When the rule D is satisfied, it is determined as an important section.

### (Rule D)

Each speech section includes necessary speech in any order, and the speech sections transition in the specified order. For example, in a speech section (type 11) for confirming an issue of the call (request content), a speech for listening to a schedule and request content is included. In the speech section (type 12) of the client environment confirmation, the speech of the network status, the speech of terminal information to be used, and the speech of asking about the demand are included as the speech of the operator. Furthermore, the speech section of the request content responding (type 13) includes a speech of confirmation of the requested content, an execution place, a schedule, and a contact address.

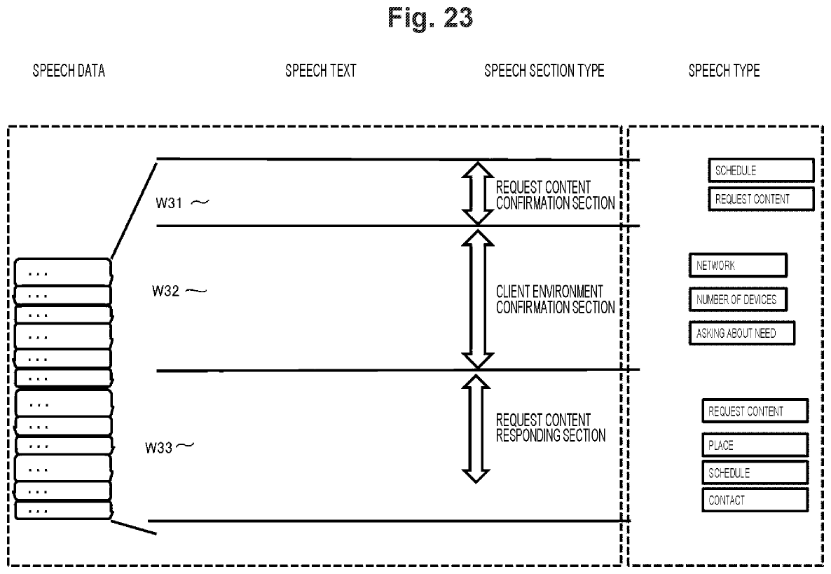

Next, the important speech section extraction processing according to the third embodiment will be specifically described with reference to FIG. 23.

FIG. 23 is a diagram for explaining the important speech section extraction processing according to the third embodiment. The speech text (not illustrated) illustrated in FIG. 23 includes a speech of an operator and a speech of a client (customer). The speech text includes a plurality of speech sections W31 to W33, and each of the speech sections W31 to W33 includes a plurality of speeches.

As illustrated in FIG. 23, the speech section type of the speech section W31 is the “request content confirmation section”, the speech section type of the speech section W32 is the “client environment confirmation section”, and the speech section type of the speech section W33 is the “request content responding section”. The speech section W31 includes speeches of “schedule” and “request content”, the speech section W32 includes speeches of “network”, “number of devices”, and “asking about need”, and the speech section W33 includes speeches of “request content”, “place”, “schedule”, and “contact information”.

In the example of FIG. 23, as described above, a combination of speech section types indicating a plurality of continuous speech sections designated in advance as the important section is included, and a combination of speech types indicating speeches designated in advance in each of the plurality of continuous speech sections is included. That is, in the speech sections W31 to W33, the combination of the speech section types is a transition of “request content confirmation section”→“client environment confirmation section”→“request content responding section”. The “request content confirmation section” includes a combination (in no particular order) of speeches of the “schedule” and the “request content”, the “clients environment confirmation section” includes a combination (in no particular order) of speeches of the “network”, the “number of devices”, and the “asking about need”, and the “request content responding section” includes a combination (in no particular order) of speeches of the “request content”, the “place”, the “schedule”, and the “contact address”. Therefore, the speech section is extracted as an important (excellent) speech section.

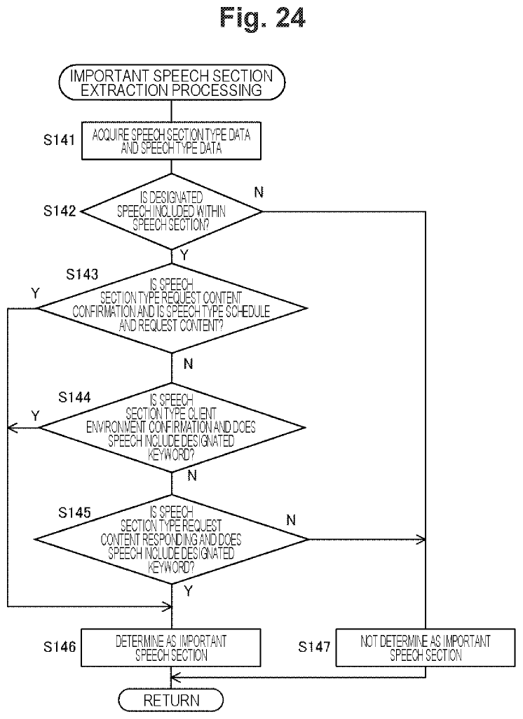

Next, the speech section extraction processing according to the third embodiment will be described with reference to FIG. 24.

FIG. 24 is a flowchart illustrating an example of a flow of speech section extraction processing according to the third embodiment, and illustrates an example of a rule D of the speech section extraction rule 33.

In step S141, the CPU 11 acquires speech section type data from the speech section type DB 23, and acquires speech type data from the speech type DB 24.

In step S142, the CPU 11 determines whether a specified speech is included in the speech section from the speech section type data and the speech type data acquired in step S141. When it is determined that the specified speech is included (in the case of the positive determination), the process proceeds to step S143, and when it is determined that the specified speech is not included (in the case of the negative determination), the process proceeds to step S147.

In step S143, the CPU 11 determines whether the speech section type is the “request content confirmation section” and the speech type includes the “schedule” and the “request content.” When it is determined that the speech section type is the “request content confirmation section” and the speech types include the “schedule” and the “request content” (in the case of positive determination), the process proceeds to step S146. When it is determined that the speech section type is the “request content confirmation section” and the speech types do not include the “schedule” and the “request content” (in the case of negative determination), the process proceeds to step S144.

In step S144, the CPU 11 determines whether the speech section type is the “client environment confirmation section” and the speech includes a specified keyword such as “network” or “number of devices”. When it is determined that the speech section type is the “client environment confirmation section” and the speech includes the specified keyword (in the case of positive determination), the process proceeds to step S146, and when it is determined that the speech section type is the “client environment confirmation section” and the speech type does not include the designated keyword (in the case of negative determination), the process proceeds to step S145.

In step S145, the CPU 11 determines whether the speech section type is the “request content responding section” and the speech includes a specified keyword such as “repeat-confirmation”, “place”, or “schedule”. When it is determined that the speech section type is the “request content responding section” and the speech includes the specified keyword (in the case of positive determination), the process proceeds to step S146, and when it is determined that the speech section type is the “request content responding section” and the speech type does not include the designated keyword (in the case of negative determination), the process proceeds to step S147.

In step S146, the CPU 11 determines that the speech section is an important speech section, and the process returns to above-mentioned step S106 in FIG. 10.

In step S147, the CPU 11 determines that the speech sections are not important speech sections, and the process returns to above-mentioned step S106 in FIG. 10.

As described above, according to the present embodiment, even when one speech section includes a plurality of speeches and is applied to check the compliance of a talk script, it is possible to accurately extract an important speech section by considering each combination and transition of the speech section type and the speech type.

Note that the speech section extraction processing executed by the CPU 11 reading the speech section extraction program in the above embodiment may be executed by various processors other than the CPU 11. Examples of the processors in this case include a programmable logic device (PLD), a circuit configuration of which can be changed after manufacturing, such as a field-programmable gate array (FPGA), and a dedicated electric circuit that is a processor having a circuit configuration exclusively designed for executing a specific process, such as an application specific integrated circuit (ASIC). In addition, the speech section extraction processing may be executed by one of these various processors or may be executed by a combination of the same processors or two or more different types of processors (for example, a plurality of FPGAs, a combination of a CPU and an EPGA, or the like). More specifically, a hardware structure of the various processors is an electric circuit in which circuit elements such as semiconductor elements are combined.

Further, in each of the above embodiments, the aspect in which the speech section extraction program is stored (also referred to as “installed”) in advance in the ROM 12 or the storage 14 has been described, but the present embodiment is not limited thereto. The speech section extraction program may be provided in the form of a program stored in a non-transitory storage medium such as a compact disk read only memory (CD-ROM), a digital versatile disk read only memory (DVD-ROM), or a universal serial bus (USB) memory. In addition, the speech section extraction program may be downloaded from an external device via a network.

All documents, patent applications, and technical standards described in this specification are incorporated herein by reference to the same extent as in a case where a case where incorporation by reference of each document, patent application, and technical standard is specifically and individually described.

Regarding the above embodiments, the following supplementary notes are further disclosed herein.

### (Supplementary Note 1)

A speech section extraction device including:
a memory; and
at least one processor connected to the memory,
wherein the processor is configured to perform
identifying a speech section including at least one speech from speech text data including speeches of two or more people;
determining a speech section type for each of the speech sections that has been identified; extracting a speech type of each speech included in the speech text data from the speech text data; and
extracting an important speech section among the speech sections that have been identified, based on a combination and transition of the speech section types that has been determined, and a combination and transition of the speech types that has been extracted.

### (Supplementary Note 2)

A non-transitory storage medium storing a program that can be executed by a computer to perform speech section extraction processing,
the speech section extraction processing including: identifying a speech section including at least one speech from speech text data including speeches of two or more people;
determining a speech section type for each of the speech sections that has been identified;
extracting a speech type of each speech included in the speech text data from the speech text data; and
extracting an important speech section among the speech sections that have been identified, based on a combination and transition of the speech section types that has been determined, and a combination and transition of the speech types that has been extracted.

### REFERENCE SIGNS LIST

10 Speech section extraction device

11 CPU

12 ROM

13 RAM

14 Storage

15 Input unit

16 Display unit

17 Communication I/F

18 Bus

20 Speech DB

21 Speech text DB

22 Speech section DB

23 Speech section type DB

24 Speech type DB

25 Extraction result DB

30 Speech section identification model

31 Speech section type determination model

32 Speech type extraction model

33 Speech section extraction rule

101 Sentence input unit

102, 102A Speech section identification unit

103, 103A, 103B Speech section type determination unit

104, 104A, 104B Speech type extraction unit

105, 105A, 105B Speech section extraction unit

106 Output unit

1. A speech section extraction device comprising:
a speech section identification unit that identifies a speech section including at least one speech from speech text data including speeches of two or more people;
a speech section type determination unit that determines a speech section type of each of the speech sections identified by the speech section identification unit;
a speech type extraction unit that extracts a speech type of each speech included in the speech text data from the speech text data; and
a speech section extraction unit that extracts an important speech section among speech sections identified by the speech section identification unit, based on a combination and transition of the speech section types determined by the speech section type determination unit, and a combination and transition of the speech types extracted by the speech type extraction unit.

2. The speech section extraction device according to claim 1,
wherein the speech section extraction unit extracts the important speech section using a speech section extraction rule in which a combination and a transition of the speech section type and a combination and a transition of the speech type are determined in advance in association with the important speech section.

3. The speech section extraction device according to claim 2,
wherein the speech text data includes a speech of an operator and a speech of a client,
the speech section is a plurality of speech sections each including a plurality of speeches, and
when the speech type indicating a speech regarding sales performed by the operator for the client is included and a combination of speech section types indicating a plurality of continuous speech sections specified in advance as an unimportant section is not included, the speech section extraction rule extracts the plurality of speech sections as the important speech section.

4. The speech section extraction device according to claim 3,
wherein the combination of the plurality of continuous speech sections specified in advance as the unimportant section is a combination that includes at least one of an “open type sales section” and an “end type sales section” among the “open type sales section”, a “theme type sales section”, and the “end type sales section”, and does not include the “theme type sales section”.

5. The speech section extraction device according to claim 2,
wherein the speech text data includes a speech of an operator and a speech of a client, and
the speech section is a plurality of speech sections each including one speech, and
when a speech type indicating a speech expressing that there is no need of the client when the operator conducts sales with the client is not included and a speech section type indicating a speech section in which the operator asks a question to the client before a speech type indicating a speech of the operator proposing to the client is included, the speech section extraction rule extracts one group including the plurality of speech sections as the important speech section.

6. The speech section extraction device according to claim 2,
wherein the speech section includes a plurality of speech sections each including a plurality of speeches, and
when a combination of speech section types indicating a plurality of continuous speech sections specified in advance as the important section is included, and a combination of speech types indicating speeches specified in advance in each of the plurality of continuous speech sections is included, the speech section extraction rule extracts the plurality of speech sections as the important speech section.

7. A speech section extraction method comprising:
identifying a speech section including at least one speech from speech text data including speeches of two or more people;
determining a speech section type of each of the speech sections that has been identified;
extracting a speech type of each speech included in the speech text data from the speech text data; and
extracting an important speech section among the speech section that has been identified, based on a combination and transition of the speech section types that has been determined, and a combination and transition of the speech type that has been extracted.

8. A speech section extraction program that causes a computer to execute:
identifying a speech section including at least one speech from speech text data including speeches of two or more people;
determining a speech section type of each of the speech section that has been identified;
extracting a speech type of each speech included in the speech text data from the speech text data; and
extracting an important speech section among the speech section that has been identified, based on a combination and transition of the speech section type that has been determined, and a combination and transition of the speech type that has been extracted.

9. The speech section extraction method according to claim 7,
wherein the speech section extraction unit extracts the important speech section using a speech section extraction rule in which a combination and a transition of the speech section type and a combination and a transition of the speech type are determined in advance in association with the important speech section.

10. The speech section extraction method according to claim 9,
wherein the speech text data includes a speech of an operator and a speech of a client,
the speech section is a plurality of speech sections each including a plurality of speeches, and
when the speech type indicating a speech regarding sales performed by the operator for the client is included and a combination of speech section types indicating a plurality of continuous speech sections specified in advance as an unimportant section is not included, the speech section extraction rule extracts the plurality of speech sections as the important speech section.

11. The speech section extraction method according to claim 10,
wherein the combination of the plurality of continuous speech sections specified in advance as the unimportant section is a combination that includes at least one of an “open type sales section” and an “end type sales section” among the “open type sales section”, a “theme type sales section”, and the “end type sales section”, and does not include the “theme type sales section”.

12. The speech section extraction device according to claim 9,
wherein the speech text data includes a speech of an operator and a speech of a client, and
the speech section is a plurality of speech sections each including one speech, and
when a speech type indicating a speech expressing that there is no need of the client when the operator conducts sales with the client is not included and a speech section type indicating a speech section in which the operator asks a question to the client before a speech type indicating a speech of the operator proposing to the client is included, the speech section extraction rule extracts one group including the plurality of speech sections as the important speech section.

13. The speech section extraction device according to claim 9,
wherein the speech section includes a plurality of speech sections each including a plurality of speeches, and
when a combination of speech section types indicating a plurality of continuous speech sections specified in advance as the important section is included, and a combination of speech types indicating speeches specified in advance in each of the plurality of continuous speech sections is included, the speech section extraction rule extracts the plurality of speech sections as the important speech section.

14. The speech section extraction program according to claim 8,
wherein the speech section extraction unit extracts the important speech section using a speech section extraction rule in which a combination and a transition of the speech section type and a combination and a transition of the speech type are determined in advance in association with the important speech section.

15. The speech section extraction program according to claim 14,
wherein the speech text data includes a speech of an operator and a speech of a client,
the speech section is a plurality of speech sections each including a plurality of speeches, and
when the speech type indicating a speech regarding sales performed by the operator for the client is included and a combination of speech section types indicating a plurality of continuous speech sections specified in advance as an unimportant section is not included, the speech section extraction rule extracts the plurality of speech sections as the important speech section.

16. The speech section extraction program according to claim 15,
wherein the combination of the plurality of continuous speech sections specified in advance as the unimportant section is a combination that includes at least one of an “open type sales section” and an “end type sales section” among the “open type sales section”, a “theme type sales section”, and the “end type sales section”, and does not include the “theme type sales section”

17. The speech section extraction program according to claim 15,
wherein the speech text data includes a speech of an operator and a speech of a client, and
the speech section is a plurality of speech sections each including one speech, and
when a speech type indicating a speech expressing that there is no need of the client when the operator conducts sales with the client is not included and a speech section type indicating a speech section in which the operator asks a question to the client before a speech type indicating a speech of the operator proposing to the client is included, the speech section extraction rule extracts one group including the plurality of speech sections as the important speech section.

18. The speech section extraction device according to claim 15,
wherein the speech section includes a plurality of speech sections each including a plurality of speeches, and
when a combination of speech section types indicating a plurality of continuous speech sections specified in advance as the important section is included, and a combination of speech types indicating speeches specified in advance in each of the plurality of continuous speech sections is included, the speech section extraction rule extracts the plurality of speech sections as the important speech section.

19. The speech section extraction device according to claim 1, further comprising an utterance segment type determination model, wherein the utterance segment type determination model is a trained model that receives utterance segment data and outputs utterance segment type data.

20. The speech section extraction device according to claim 19, wherein the determination model for determining utterance segment types is generated in advance by performing machine learning using labeled learning data.
